(19) United States
(12) Patent Application Publication
(10) Pub. No.: US 2009/0140951 A1
(43) Pub. Date: Jun. 4, 2009

(54) PLASMA DISPLAY PANEL

(75) Inventors: Noriaki SETOGUCHI, Miyazaki (JP); Masahiro Sawa, Miyazaki (JP); Yoshimi Kawanami, Miyazaki (JP)

Correspondence Address: MILES & STOCKBRIDGE PC, 1751 PINNACLE DRIVE, SUITE 500, MCLEAN, VA, 22102-3833, US

(73) Assignee: HITACHI, LTD.

(21) Appl. No.: 12/187,490

(22) Filed: Aug. 7, 2008

(30) Foreign Application Priority Data
Nov. 30, 2007 (JP) 2007-310488

(51) Int. Cl. G09G 3/28

(52) U.S. Cl. 345/60

(57) ABSTRACT

A technology capable of stably maintaining the address discharge characteristics even in a long-term drive of a PDP is provided. A PDP has a structure where projecting portions are provided to a display electrode pair used for surface discharge so as to extend toward a reverse slit side in a cell region. Address discharge is performed between a scan electrode having the projecting portion and an address electrode. Since surface discharge in the display electrode pair and address discharge using the projecting portion are positionally separated from each other in this structure, address discharge characteristics are stabilized even if a protective layer is degraded due to the surface discharge.

### CROSS-REFERENCE TO RELATED APPLICATION

The present application claims priority from Japanese Patent Application No. JP 2007-310488 filed on Nov. 30, 2007, the content of which is hereby incorporated by reference into this application.

### TECHNICAL FIELD OF THE INVENTION

The present invention relates to a plasma display panel (PDP) and a display apparatus having the same (plasma display apparatus: PDP apparatus), and more particularly to a cell structure including electrodes, discharge characteristics, and the like.

### BACKGROUND OF THE INVENTION

As a flat-type PDP apparatus, a surface discharge AC drive PDP apparatus has been put into practical use and has been widely utilized. In a PDP (panel), high performance and low cost as well as high reliability are demanded.

In a PDP apparatus performing the surface discharge, all pixels (cells) on a panel screen (display region) are caused to emit light simultaneously in response to display data. The surface discharge is also referred to as display discharge or sustain discharge. The electrodes (electrode pair) where the surface discharge is performed are referred to as display electrodes or the like. The display electrode pair is composed of, for example, a sustain electrode (X electrode) and a scan electrode (Y electrode).

For example, a panel of the PDP apparatus performing the surface discharge has a structure where electrode pairs used for the surface discharge are formed on a front glass substrate of a front substrate structure, a dielectric layer and further a protective layer are formed so as to cover the electrode pairs, and rare gas (discharge gas) is filled in an inner space (discharge space) of the panel. Also, phosphors of respective three primary colors of red (R), green (G), and blue (B) are formed between barrier ribs partitioning the discharge space on a rear glass substrate of a rear substrate structure. When drive voltage for surface discharge is applied between the electrodes, the surface discharge occurs on a surface of the dielectric layer and the protective layer on the electrode surface, so that ultraviolet light is generated. The respective phosphors are caused to emit light by the ultraviolet light, thereby performing the color display.

The protective layer formed to be exposed to the discharge space is formed of a layer of, for example, magnesium oxide (MgO), and it has a discharge protecting function and a secondary electron supplying (emission) function to the discharge space. In a current (conventionally mainstream) PDP apparatus, the surface discharge is performed by the display electrode pair (X electrode, Y electrode), but when the surface discharge is repeated in the accumulation of the long-term drive of the PDP, the protective layer (MgO) is sputtered and degraded, which results in the degradation of a panel life.

As examples of the conventional technology where a projection-shaped (or overhang-shaped) electrode portion is provided to the display electrode pair, there are the following examples.

In the technology described in Japanese Patent Application Laid-Open Publication No. 2000-113828 (Patent Document 1), row electrodes (electrode pair constituting a display line (row) and performing surface discharge) arranged at equal intervals are provided, and projecting portions overhung on both sides in a column direction are provided for bus electrodes of the respective row electrodes. This technology discloses a structure where the projecting portions on the both sides are used for the surface discharge and a reverse slit which does not perform the surface discharge is not provided, and a projection-shaped electrode portion toward the reverse slit is not provided.

In the technology described in Japanese Patent Application Laid-Open Publication No. 2003-86108 (Patent Document 2), projecting portions overhung on both sides in a column direction are provided for bus electrodes of respective row electrodes similarly to Patent Document 1. In this technology, respective bus electrodes are disposed at positions where they overlap with barrier ribs, and cells are classified into first cells in which the surface discharge is performed and second cells in which reset and address are performed, the first and second cells both being surrounded by barrier ribs. The projecting portions used for address are included in the second cells but not included in the first cells where the surface discharge is performed.

In the technology described in Japanese Patent Application Laid-Open Publication No. 2005-135732 (Patent Document 3), electrodes positioned on the discharge cell side are transparent electrodes and electrodes projecting on an opposite side are metal electrodes. In this technology, even the electrodes projecting to the opposite side perform the surface discharge, and a display cell and an auxiliary cell are partitioned by a rib.

### SUMMARY OF THE INVENTION

Conventionally, the protective layer (MgO or the like) degrades due to the above-mentioned surface discharge, and the biggest problem caused by the degraded protective layer is the increase of discharge delay. In particular, the increase of discharge delay at the address discharge in an address drive period makes an address (cell selection) operation unstable, which causes the display defect due to address error.

The present invention has been made in consideration of the problems described above, and a main object thereof is to provide a technology capable of stably maintaining the address discharge characteristics even in a long-term drive of a PDP, particularly, a technology capable of suppressing the discharge delay in the address discharge influenced by the degradation of a protective layer due to the surface discharge.

The typical ones of the inventions disclosed in this application will be briefly described as follows. In order to achieve the above object, a typical embodiment of the present invention is directed to a technology of a PDP and has the following configuration.

According to the PDP structure of the present invention, in an electrode pair used for surface discharge, a projection-shaped electrode portion (referred to as projecting portion) is provided for a slit (reverse slit) on a side opposite to a slit (normal slit) provided on a side where the surface discharge is performed (side to be a display line). By this means, even if the protective layer (MgO or the like) is degraded by surface discharge at the electrode pair, address discharge is performed using a projecting portion apart from the degraded portion. Depending on the degree of degradation of the protective layer, the address discharge can be performed at a portion where the degradation of the protective layer is relatively small, in other words, at a position apart from a portion where the degradation is relatively large toward the projecting portion, namely, apart from the discharge gap. Since the address discharge can be performed without being largely influenced by the degradation of the protective layer due to surface discharge, characteristics of the address discharge can be stabilized for a long term. For example, the PDP of the present invention has the following configuration.

(1) The PDP according to the present invention comprises: a substrate structure having a discharge space which is partitioned by barrier ribs and in which phosphors are formed, and the substrate structure includes pairs of first and second electrodes used for surface discharge and extending in a first direction and third electrodes used for address discharge performed between the third electrode and the second electrode and extending in a second direction intersecting with the first direction. Also, display cells are formed correspondingly to intersections of these electrodes. A protective layer covering the first and second electrodes and exposed to the discharge space is provided, and a slit on one side in the pair of the first and second electrodes is used for the surface discharge and a slit on an opposite side is not used for the surface discharge. Further, in this PDP, first projection-shaped electrode portions used for the address discharge are provided to the second electrode so as to extend toward the slit on the opposite side and be included in a region of the discharge space corresponding to the display cell.

(2) In addition to the above configuration (1), the display electrode pairs have projection-shaped electrode portions (electrode pairs configuring the surface discharge gap) on a normal slit side.

(3) In addition to the above configuration (2), the projection-shaped electrode portions on the normal slit side are formed of transparent electrodes made of ITO or the like, and the projection-shaped electrode portions on the reverse slit side are made of the same material as metal bus electrodes.

(4) In addition to the above configuration (1), a pad portion of the address electrode is provided at a position, which intersects with a region (area) of the projecting portion on the reverse slit side in a direction perpendicular to a panel surface, so that an area of the intersecting portion is made large.

The effects obtained by typical aspects of the present invention will be briefly described below. According to the typical embodiment of the present invention, the address discharge characteristics can be stably maintained even in the long-term driving of a PDP, and in particular, discharge delay of address discharge influenced by the degradation of a protective layer due to surface discharge can be suppressed.

### BRIEF DESCRIPTIONS OF THE DRAWINGS

These and other features, objects and advantages of the present invention will become more apparent from the following description when taken in conjunction with the accompanying drawings wherein:

FIG. 1 is a diagram showing a block configuration of a whole PDP apparatus according to an embodiment of the present invention;

FIG. 2 is an exploded perspective view of one example of a basic structure of a PDP according to an embodiment of the present invention;

FIG. 3 is a plan view schematically showing a structure of cells, electrodes and others viewed from a front side of a PDP according to a first embodiment of the present invention;

FIG. 4 is a cross sectional view showing a structure of the cells, the electrodes and others in a section (A) taken along a display line direction (x direction) in the PDP according to the first embodiment of the present invention;

FIG. 5 is a cross sectional view showing a structure of the cells, the electrodes and others in a section (B) taken along a display column direction (y direction) in the PDP according to the first embodiment of the present invention;

FIG. 6 is a plan view schematically showing a structure of cells, electrodes and others viewed from a front side of a PDP according to a second embodiment of the present invention;

FIG. 7 is a cross sectional view showing a structure of the cells, the electrodes and others in a section (B) taken along a display column direction (y direction) in the PDP according to the second embodiment of the present invention;

FIG. 8 is a plan view schematically showing a structure of cells, electrodes and others viewed from a front side of a PDP according to a third embodiment of the present invention;

FIG. 9 is a plan view schematically showing a structure of cells, electrodes and others viewed from a front side of a PDP according to a fourth embodiment of the present invention;

FIG. 10 is a plan view schematically showing a structure of cells, electrodes and others viewed from a front side of a PDP according to a fifth embodiment of the present invention;

FIG. 11A is a diagram schematically showing an example of a relationship in widths and others of the electrodes in each cell in a PDP of a modified example of the respective embodiments of the present invention;

FIG. 11B is a diagram schematically showing an example of a relationship in widths and others of the electrodes in each cell in a PDP of a modified example of the respective embodiments of the present invention;

FIG. 11C is a diagram schematically showing an example of a relationship in widths and others of the electrodes in each cell in a PDP of a modified example of the respective embodiments of the present invention;

FIG. 11D is a diagram schematically showing an example of a relationship in widths and others of the electrodes in each cell in a PDP of a modified example of the respective embodiments of the present invention;

FIG. 11E is a diagram schematically showing an example of a relationship in widths and others of the electrodes in each cell in a PDP of a modified example of the respective embodiments of the present invention;

FIG. 12 is a plan view schematically showing a structure of cells, electrodes and others viewed from a front side of a PDP according to a conventional technology;

FIG. 13 is a cross sectional view showing a structure of the cells, the electrodes and others in a section (A) taken along a display line direction (x direction) in the PDP according to the conventional technology; and

FIG. 14 is a cross sectional view showing a structure of the cells, the electrodes and others in a section (B) taken along a display column direction (y direction) in the PDP according to the conventional technology.

### DESCRIPTIONS OF THE PREFERRED EMBODIMENTS

Hereinafter, embodiments of the present invention will be described in detail with reference to the accompanying drawings. Note that components having the same function are denoted by the same reference numbers throughout the drawings for describing the embodiments, and the repetitive description thereof will be omitted.

<Outline>

In each of the PDPs according to respective embodiments, projecting portions (represented by Xc, Yc) are provided on a reverse slit side for a display electrode pair and are utilized for address discharge. In this structure, address discharge and surface discharge are positionally separated from each other because of the presence of the projecting portion (Yc). For the influence of degradation of the protective layer due to surface discharge, since a projecting portion (Yc) apart from a portion where a protective layer is largely degraded (apart from the vicinity of a surface discharge gap) is utilized, characteristics of the address discharge can be stabilized for a long term.

<Basic Configuration>

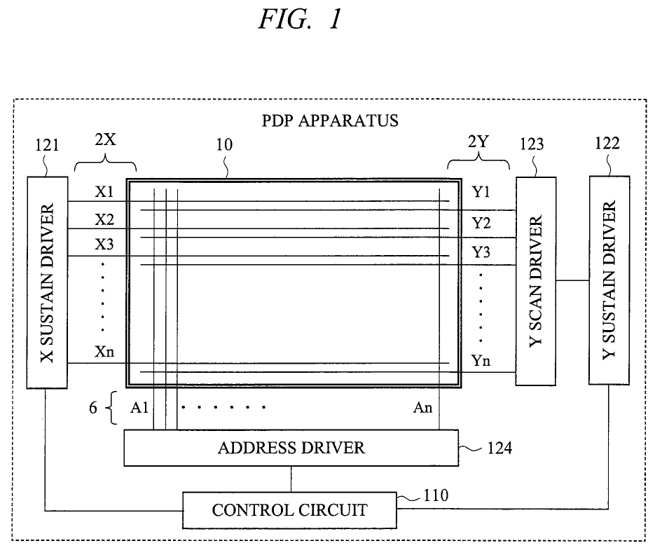

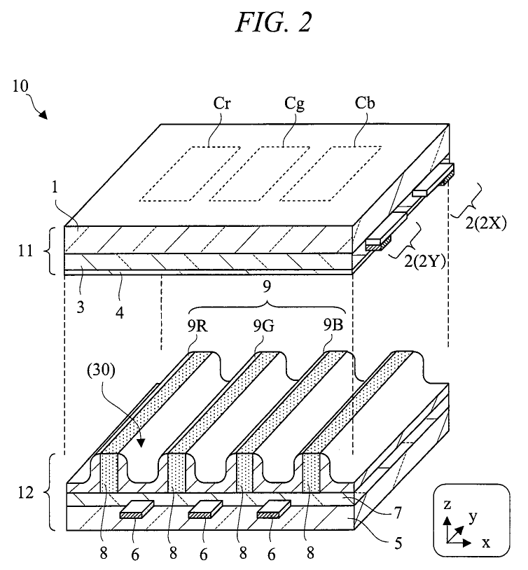

First, a basic configuration of a PDP apparatus according to an embodiment of the present invention will be described with reference to FIGS. 1 and 2, and a characteristic structure and the like will be described in detail later.

<PDP Apparatus>

FIG. 1 shows the whole configuration of a PDP apparatus according to an embodiment. The PDP apparatus is provided with a PDP (panel) 10 in which an electrode group (sustain electrodes 2X, scan electrodes 2Y, address electrodes 6) are formed, drive circuits (drivers) connected to the electrode group of the PDP 10 to apply drive voltages to the electrode group such as an X sustain driver (X electrode sustain drive circuit) 121, a Y sustain driver (Y electrode sustain drive circuit) 122, a Y scan driver (Y electrode scan drive circuit) 123, and an address driver (address electrode drive circuit) 124, and a control circuit 110 controlling the drivers.

In the PDP 10, pairs of sustain electrodes 2X (represented by symbol X) and scan electrodes 2Y (represented by symbol Y) arranged in parallel in a horizontal direction on a screen are formed as the electrodes (display electrodes) used for surface discharge (sustain discharge), so that lines (display lines) by the electrode pairs are configured. Also, address electrodes 6 (represented by symbol A) arranged in parallel in a vertical direction on the screen are formed so as to intersect with the electrode pairs, so that display columns by the electrodes are configured. Further, matrix-shaped cell (display cell) group is configured so as to correspond to the intersecting regions of the electrode groups (X, Y, A) on the screen (display region) of the PDP 10.

In the PDP apparatus, field data which is multi-value image data showing luminance levels of three colors of red (R), green (G), and blue (B), various synchronization signals (clock signal, horizontal synchronizing signal, vertical synchronizing signal) and the like are inputted from an external apparatus such as a TV tuner or a computer. Also, the control circuit 110 generates and outputs control signals suitable for respective drivers based upon the data and signals, and the drivers thus drive the corresponding electrode groups by applying voltage thereto. In this manner, image display according to a predetermined method is performed on the screen (display region) of the PDP 10.

As an example of the electrode arrangement in the PDP 10, normally, sustain electrodes 2X (X electrode: X1 to Xn) and scan electrodes 2Y (Y electrode: Y1 to Yn) which form the display electrode pairs are alternately disposed in a vertical direction within the screen in a repetitive manner, and lines formed of the electrode pairs (X-Y) are sequentially arranged. Also, cells are configured of the display electrode pairs (lines) and the address electrodes 6 (A1 to Am) intersecting with the display electrode pairs. Note that a side where a line (light emitting portion) between adjacent electrodes is configured is referred to as “normal slit”, and a non-line side (non-light emitting portion) which is an opposite side thereof is referred to as “reverse slit”.

<Driving Method>

As the driving method of the PDP apparatus, a field corresponding to the screen of the PDP 10 is driven by a sub-field method and an ADS method, so that grayscale expression and color display are performed. In a driving sequence, the field (or frame) includes a plurality of (for example, 8 to 10) sub-fields (or sub-frames) to which predetermined luminance weights are given. A desired grayscale expression is performed according to a selected combination of lighting of respective sub-fields (SF) of the field. Each SF period of one field includes respective processes (driving periods) such as a reset period, an address period, and a sustain (display) period. A ratio of the number of sustain discharges (or sustain pulses) in the sustain period varies in accordance with weights of SFs. As a method for weighting the SFs, for example, there are a method utilizing power-of-two (binary) and the like.

In the driving of the SF, the state of wall charges of all cells of the SF is initialized (preferably uniformized) in the reset process to prepare for the next address process. In the next address process, cells to be lit in the SF are selected. The Y scan driver 123 performs an operation (scan) of controlling individual Y electrodes 2Y (line) and sequentially selecting them. Simultaneously, the address driver 124 performs an operation of controlling individual address electrodes 6 and selecting them. By these operations, discharge (address discharge) for selecting the lighting (ON) and the non-lighting (OFF) of the cells for the SF is generated in (between) the pair of selected address electrodes 6 and Y electrodes 2Y.

In the next sustain process, the cells (selected cell) selected in the previous address process are lit by the number of discharge light emissions corresponding to the weight of luminance. The X sustain driver 121 and the Y sustain driver 122 apply sustain drive voltage (sustain pulse) to the display electrode (X, Y) group. By this means, a number of sustain discharges corresponding to the weight are generated in the selected cells.

<PDP>

FIG. 2 shows an example of a basic structure of the PDP 10. In FIG. 2, portions of cells (Cr, Cg, Cb) of respective colors of R, G, and B that form a pixel are shown. This example employs a three-electrode (X, Y, A) surface discharge/AC drive type PDP or a stripe rib type PDP. Note that an x direction (first direction, horizontal direction within screen), a y direction (second direction, vertical direction within screen), a z direction (third direction, vertical direction to panel surface) are defined for the convenience of description. Respective cells (Cr, Cg, Cb) correspond to regions (areas or volumes) where discharge and light emission occur.

The PDP 10 is configured by combining two structures (11, 12) composed of two glass substrates 1 and 5 positioned on a front side and a rear side. Outer peripheral portions of the two structures (11, 12) are sealed, and a discharge space 30 is formed in a region between the structures by exhausting air from the region and filling discharge gas in the region.

In the first structure (front substrate structure) 11, display electrode 2 pairs (X electrode 2X, Y electrode 2Y) are formed on the glass substrate (front glass substrate) 1 in the x direction. As the display electrodes 2, sustain electrodes 2X (X electrode) for sustain drive and scan electrodes 2Y (Y electrode) for both sustain drive and scan drive are provided. The display electrode 2 is composed of, for example, a transparent electrode and a bus electrode. The display electrode 2 pairs are covered with a dielectric layer 3 and the dielectric layer 3 is further covered with a protective layer 4. The protective layer 4 is exposed to the discharge space.

In the second structure (rear substrate structure) 12, address electrodes 6 for address drive are formed on the glass substrate (rear glass substrate) 5 in the y direction. The address electrodes 6 are covered with, for example, a dielectric layer 7, and barrier ribs 8 (vertical ribs) are further formed on the dielectric layer 7 so as to extend in, for example, the y direction. The barrier ribs 8 partition the discharge space 30 correspondingly to respective cells (display columns). On the regions on the dielectric layer 7 between the barrier ribs 8, in particular, on a surface of the dielectric layer 7 and side surfaces of the barrier ribs 8, phosphors 9 of respective colors (9R, 9G, 9B) are formed in a repetitive manner for each display column for respective colors so as to be exposed to the discharge space 30.

<Conventional PDP>

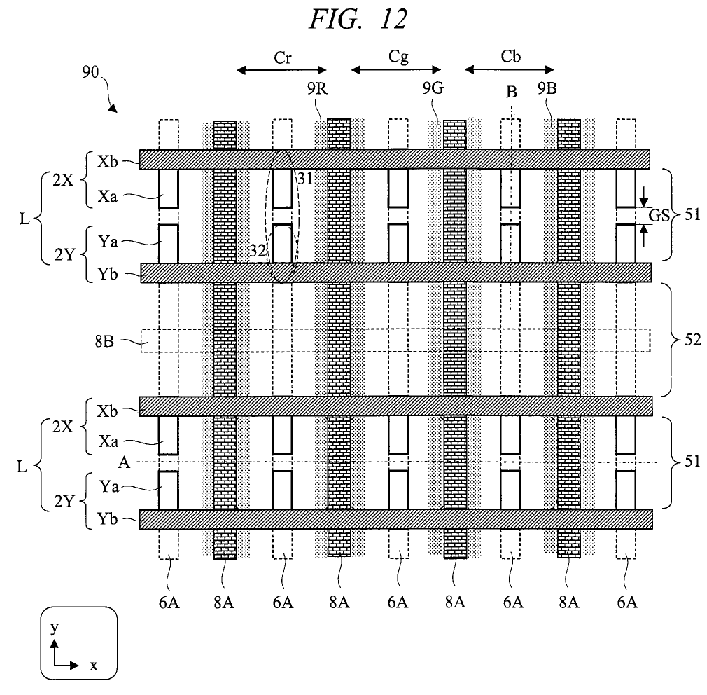

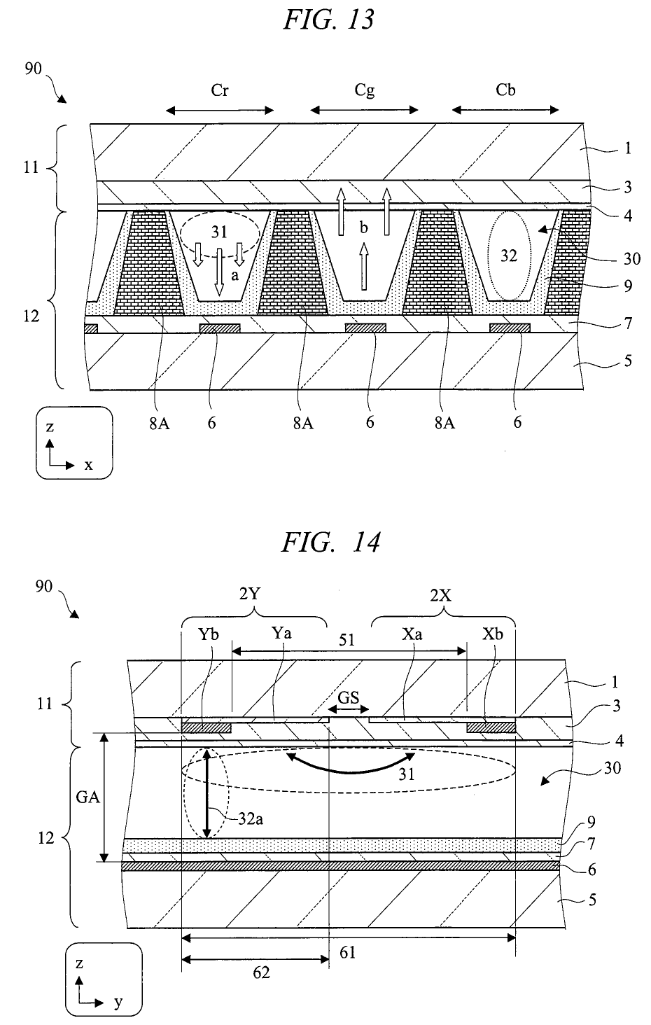

Next, a structure and a discharge operation of a PDP 90 according to a conventional technology will be described for comparison with reference to FIGS. 12 to 14. In this example, transparent electrodes (Xa, Ya) overhung toward inside of the cell are provided in each cell in the panel structure as shown in FIG. 2. The structure is viewed from its front side, and its width, ratio and the like are mere examples. FIG. 12 shows a schematic configuration of the electrodes and others in a planar (x-y) structure corresponding to a display region of the conventional PDP 90. Also, FIG. 13 shows a section A in a display line direction (x-z) shown in FIG. 12. Further, FIG. 14 shows a section B in a display column direction (y-z) shown in FIG. 12.

In FIG. 12, lines L (normal slit 51) each composed of the display electrode 2 pair (2X, 2Y) and a region (reverse slit 52) between the lines L are provided. The normal slit 51 corresponds to a light emission portion and the reverse slit 52 corresponds to a non-light emission portion. The X electrode 2X and the Y electrode 2Y are composed of linear bus electrodes Xb and Yb and transparent electrodes Xa and Ya electrically connected thereto and overhung toward the normal slit 51. A surface discharge gap GS is configured by the transparent electrode pair (Xa, Ya) for each cell.

Also, the structures such as the ribs 8 (vertical ribs 8A), the phosphors 9 (9R, 9G, 9B), and others similar to those shown in FIG. 2 are provided, and cells corresponding to respective colors and corresponding display columns are shown by Cr, Cg, and Cb. Note that the illustration of the phosphors 9 is omitted, and only a portion formed on the side surface of the vertical rib 8A is shown. Further, an address electrode position 6A shown by a broken line is, for example, a center position between the vertical ribs 8A and it is a position overlapping with the transparent electrodes (Xa, Ya). In this case, a width of the address electrode 6 is approximately equal to a width of the bus electrode (Xb, Yb) and the transparent electrode (Xa, Ya).

Furthermore, as the structure of the rib 8, for example, the structure in which not only barrier ribs in the y direction (vertical ribs 8A) but also barrier ribs in the x direction (lateral ribs) are provided (box rib) can also be used. A lateral rib position 8B is shown as an arrangement example in the case where the lateral rib is present, and for example, it may be an intermediate position of the reverse slit 52. Alternatively, the lateral rib position 8B may be a position overlapping with the bus electrodes (Xb, Yb). In the case where no lateral rib is provided, for example, the configuration where a distance of the electrode pair on the side of the reverse slit 52 is larger than a distance of the electrode pair on the side of the normal slit 51 is adopted. Also, in the case where the lateral rib is provided, a distance of the electrode pair on the side of the reverse slit 52 can be made small. The above-mentioned distance is designed in consideration of mutual influence of discharge or the like in the cells adjacent to each other in the y direction.

In FIG. 12, when viewed on the screen, a light emission region corresponding to a cell is a portion surrounded by the vertical ribs 8A and the bus electrodes (Xb, Yb). The bus electrodes (Xb, Yb) are a non-light emission region made of a non-transparent metal material. The transparent electrode (Xa, Ya) is made of, for example, ITO (indium tin oxide), and it has a linear main portion overlapping on the bus electrode (Xb, Yb) and a rectangular portion overhung from the main portion toward inside of the cell to configure a surface discharge gap GS. The bus electrode (Xb, Yb) has an electric resistance lower than that of the transparent electrode (Xa, Ya).

In FIG. 14, the display electrode 2 (2X, 2Y) is configured by stacking the transparent electrode (Xa, Ya) and the bus electrode (Xb, Yb) on the glass substrate 1 in this order. The surface discharge gap GS is a distance between distal ends of the transparent electrodes (Xa, Ya), and it is positioned at the center of the cell. The address discharge gap GA is shown as a distance between the address electrode 6 and the bus electrode Yb, for example.

In FIGS. 12 to 14, a region 31 indicated by an ellipse (surface discharge region) shows a schematic shape and range of the surface discharge. A range 61 is a range corresponding to the region 31 in the y direction. The centers of the region 31 and the range 61 are positioned near the surface discharge gap GS and a surface of the protective layer 4. Since the bus electrodes (Xb, Yb) and the transparent electrodes (Xa, Ya) of the display electrodes 2 (2X, 2Y) are involved in the surface discharge, the outer boundaries of the region 31 and the range 61 are shown as the portions including them. By applying drive voltage to the display electrode 2 pair (2X, 2Y), the surface discharge (sustain discharge) occurs between the electrodes (surface discharge gap GS) near a surface of the dielectric layer 3 and the protective layer 4 on an upper side in the discharge space 30. By the surface discharge, ultraviolet light is generated to collide with the phosphor 9 as shown by “a” in FIG. 13, so that light is emitted from the phosphor 9 as shown by “b” and penetrated in a front surface direction, thereby producing the luminance. Therefore, a region in the vicinity between the electrodes (surface discharge gap GS) is the most intense light emission region, and thus the protective layer 4 is degraded most easily in the region.

A region 32 indicated by an ellipse (address discharge region) shows a schematic shape and range of the address discharge. A range 62 is a range corresponding to the region 32 in the y direction. Particularly, a region 32a shown in FIG. 14 shows a main (central) position of the region 32 and the range 62 of the address discharge. The centers of the region 32 and the range 62 are positioned near a lower side of the bus electrode Yb in this example. The region 32a indicates a position of the address discharge in the case where the address discharge occurs intensely on a lower side of the bus electrode Yb. Since the bus electrode Yb and the transparent electrode Ya of the Y electrode 2Y are involved in the address discharge, the outer boundaries of the region 32 and the range 62 are shown as the portions including them. Specifically, if the transparent electrode Ya and the like are taken into consideration, the shape and the position of the address discharge become complicated, but it does not matter if it is considered schematically. By applying drive voltage to the pair of the address electrode 6 and the Y electrode 2Y, the address discharge occurs in the discharge space 30 between the electrodes (address discharge gap GA). By the discharge, wall charges are accumulated in the cell.

In the structure of the conventional PDP 90, as shown in FIGS. 12 and 14, the region 31 of surface discharge and the region 32 of address discharge partially overlap with each other. Therefore, the address discharge performed between the Y electrode 2Y and the address electrode 6 via the protective layer 4 degraded due to surface discharge is influenced. The protective layer 4 gradually degrades due to the repetition of surface discharge in the accumulation of a long-term drive of the PDP 90. The secondary electron supply performance lowers in the degraded portion of the protective layer 4. A portion of the protective layer 4 corresponding to the range 62 of the address discharge also gradually degrades. With this degradation, characteristics of the address discharge are changed (degraded). More specifically, due to the deterioration of the secondary electron supply performance, the discharge delay in the address discharge is increased and the address discharge becomes unstable, so that address error occurs frequently.

Further, a region positioned on a lower side of the bus electrodes (Xb, Yb) in the discharge space 30 and a region positioned on an outer side thereof also influence the occurrence of discharge if they are not partitioned by the ribs 8 and the like. Since a discharge form as described above changes according to a panel structure or the like, it is shown only schematically.

### First Embodiment

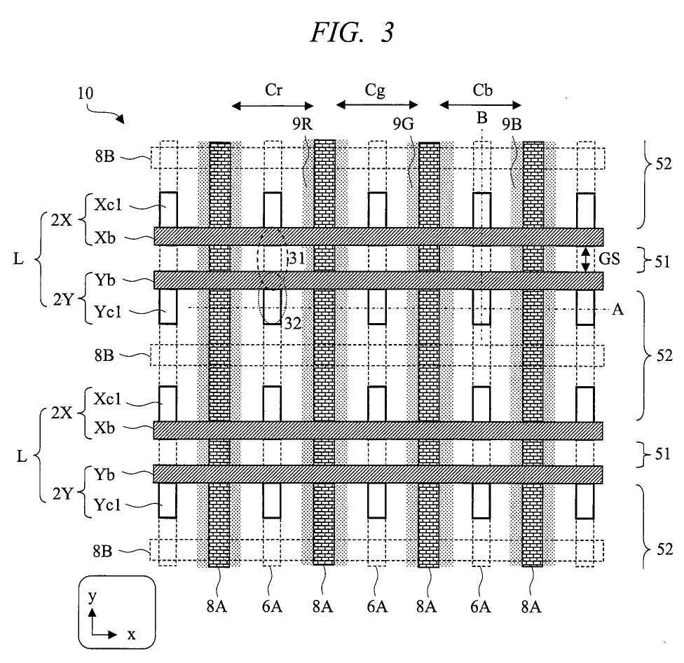

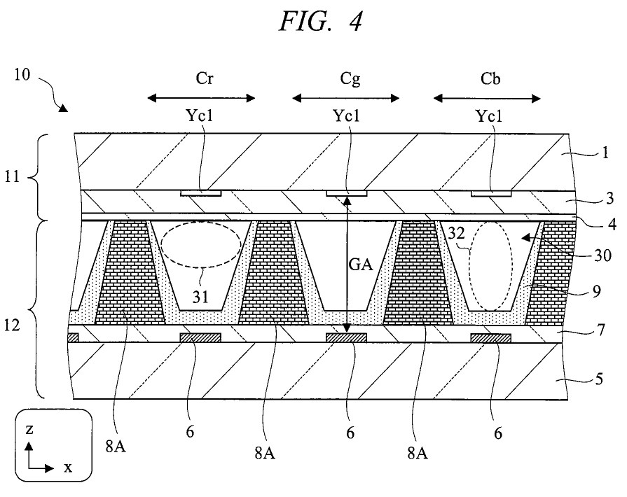

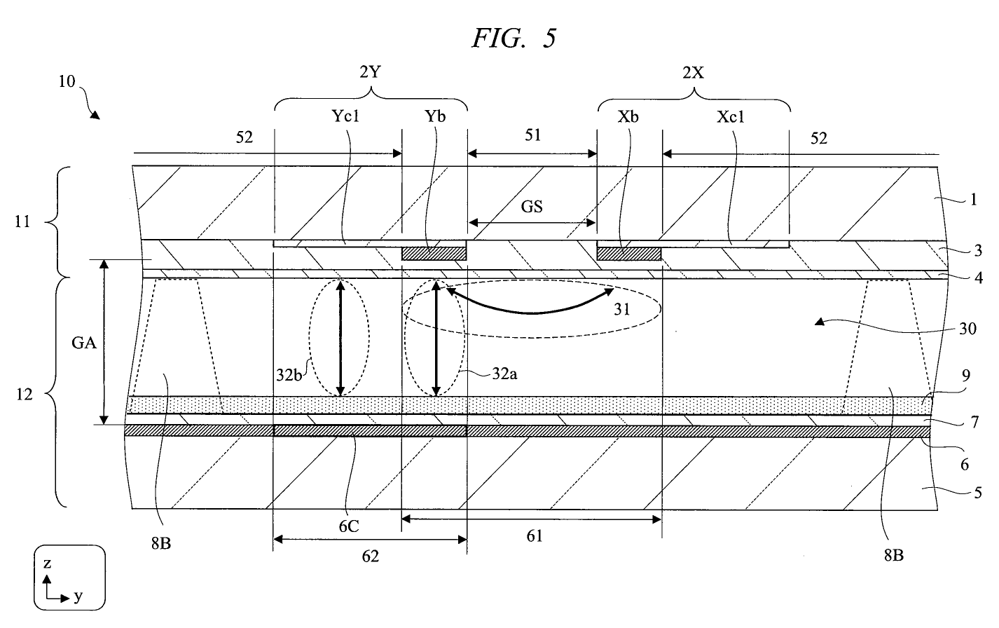

In view of the above, a PDP 10 according to a first embodiment of the present invention will be described with reference to FIGS. 3 to 5. FIG. 3 shows a planar structure of the PDP 10 in the same manner as FIG. 12. Also, FIG. 4 shows a section A in a display line direction (x-z) shown in FIG. 3. Further, FIG. 5 shows a section B in the display column direction (y-z) shown in FIG. 3. The PDP 10 has a configuration based on the panel structure in FIG. 2, in which the line L (normal slit 51) is composed of only the bus electrode pair (Xb, Yb) in the display electrode 2 pair (2X, 2Y), and the transparent electrode pair (Xa, Ya) is not provided as shown in FIG. 3. The surface discharge gap GS is a distance between the bus electrodes (Xb, Yb).

In this structure, projecting portions (Xc1, Yc1) for each cell are provided for the X electrode 2X and the Y electrode 2Y on the reverse slit 52 side with respect to the display electrode 2 pair. Address discharge is performed in the pair of (between) the Y electrode 2Y including the projecting portion Yc1 and the address electrode 6. In this structure, the surface discharge in the display electrode 2 pair and the address discharge using the projecting portion Yc1 are positionally separated from each other, and the degree of overlap between the region 31 for the surface discharge and the region 32 for the address discharge is smaller than that in the conventional PDP shown in FIG. 12, and the mutual influence is also small. Therefore, since the address discharge can be performed without being much influenced by the degradation of the protective layer 4 due to surface discharge, characteristics of the address discharge are stabilized for a long term, and the discharge delay of address discharge can be suppressed.

Note that the projecting portions (Xc1, Yc1) are present so as to be contained in a region (discharge region) of the discharge space 30 corresponding to a cell. In other words, the region 31 for surface discharge and the region 32 for address discharge are similarly contained in the region of the cell, and the discharge space 30 is not separated by the ribs or the like. By this means, operations such as reset, address and sustain in the region of the cell can be performed. As shown in FIG. 3, the discharge spaces 30 are communicated in the y direction on the normal slit 51 side and the reverse slit 52 side of the bus electrode pair (Xb, Yb) in the cell region regardless of presence/absence of lateral ribs, and the above-mentioned conditions are satisfied.

In FIG. 3, the X electrode 2X and the Y electrode 2Y are composed of linear bus electrodes Xb and Yb and projecting portions Xc1 and Yc1 electrically connected thereto and overhung toward the reverse slit 52, respectively. In the first embodiment, a material for the projecting portions (Xc1, Yc1) is, for example, ITO like the transparent electrodes (Xa, Ya) shown in FIG. 12.

Further, the ribs 8 (vertical ribs 8A), the phosphors 9 (9R, 9G, 9B), the cells of respective colors and corresponding display columns (Cr, Cg, Cb), the address electrode position 6A, the lateral rib position 8B, and the like are provided in the same manner as FIG. 2 and FIG. 12. The lateral rib position 8B is shown as an arrangement example in the case where the lateral rib is present, and for example, it may be an intermediate position of the reverse slit 52.

A light emitting region corresponding to a cell when viewed on a screen is a portion surrounded by the vertical ribs 8A and the bus electrodes (Xb, Yb). The bus electrodes (Xb, Yb) are a non-light emission region made of a non-transparent metal material. The projecting portions (Xc1, Yc1) are made of, for example, ITO (indium tin oxide) and have rectangular portions overhung toward the reverse slit 52 from the linear main portion overlapped with the bus electrodes (Xb, Yb). Further, the projecting portion Xc of the X electrode 2X has a shape symmetrical to the projecting portion Yc of the Y electrode 2Y and it is made of the same material as the projecting portion Yc.

The section A shown in FIG. 4 is a section at the position of the projecting portion Yc1 of the Y electrode 2Y. The address discharge gap GA is shown as a distance between the address electrode 6 and the projecting portion Yc1 of the Y electrode 2Y. The protective layer 4 is, for example, an MgO layer.

The section B shown in FIG. 5 is a section at the position of the address electrode 6 and the projecting portions (Xc1, Yc1). The display electrodes 2 (2X, 2Y) are configured by stacking the projecting portions (Xc1, Yc1) and the bus electrodes (Xb, Yb) made of ITO on the glass substrate 1 in this order. The surface discharge gap GS is positioned at the center of the cell. The address discharge gap GA is shown as a distance between the address electrode 6 and the bus electrode Yb.

In FIGS. 3 to 5, a region 31 indicated by an ellipse (surface discharge region) shows a schematic shape and range of the surface discharge. A range 61 is a range corresponding to the region 31 in the y direction. The centers of the region 31 and the range 61 are positioned near the surface discharge gap GS and a surface of the protective layer 4. Since the bus electrodes (Xb, Yb) and the transparent electrodes (Xa, Ya) of the display electrodes 2 (2X, 2Y) are involved in the surface discharge, the outer boundaries of the region 31 and the range 61 are shown as the portions including them. By applying drive voltage to the display electrode 2 pair (2X, 2Y), the surface discharge (sustain discharge) occurs between the electrodes (surface discharge gap GS) near a surface of the dielectric layer 3 and the protective layer 4 on an upper side in the discharge space 30. A region in the vicinity between the electrodes (surface discharge gap GS) is the most intense light emission region, and thus the protective layer 4 is degraded most easily in the region. The degradation of the protective layer 4 is relatively large as getting closer to the centers of the region 31 and the range 61, and the degradation becomes relatively smaller as being apart from the centers to outsides.

Also, a region 32 indicated by an ellipse (address discharge region) shows a schematic shape and range of the address discharge. A range 62 is a range corresponding to the region 32 in the y direction. In particular, a first region 32a shown in FIG. 5 indicates a position of the address discharge in the case where the main address discharge occurs near a lower side of the bus electrode Yb, as a first example of a main (central) position in the region 32 and range 62 for the address discharge. Since the bus electrode Yb and the projecting portion Yc1 of the Y electrode 2Y are involved in the address discharge, the outer boundaries of the region 32 and the range 62 are shown as the portions including them. Further, a second region 32b shown in FIG. 5 indicates a position of the address discharge in the case where the main address discharge occurs near a lower side of the projecting portion Yc1, as a second example of a main (central) position in the region 32 and range 62 for the address discharge. Also, a region 6C indicates a portion of the address electrode 6 corresponding to the bus electrode Yb and the projecting portion Yc1 (or a portion corresponding to a pad 6B described later).

By applying drive voltage to the pair of the address electrode 6 and the Y electrode 2Y, the address discharge occurs in the discharge space 30 between the electrodes (address discharge gap GA). By the discharge, wall charges are accumulated in the cell.

In the PDP 10 structure, as described above, the degree of overlap between the region 31 for the surface discharge and the region 32 for the address discharge is smaller than that in the conventional PDP 90 because of the presence of the projecting portion Yc1. Accordingly, the influence on the address discharge performed between the Y electrode 2Y and the address electrode 6 via the protective layer 4 degraded by the surface discharge can be reduced. The protective layer 4 gradually degrades due to the repetition of surface discharge in the accumulation of a long-term drive of the PDP 10, and the secondary electron supply performance lowers. In particular, the degradation progresses from the vicinity of the surface discharge gap GS toward the outside where the bus electrodes (Xb, Yb) and the projecting portions (Xc1, Yc1) are present. On the contrary, in a portion of the protective layer 4 corresponding to the range 62 for the address discharge, the degradation of a portion of the protective layer 4 corresponding to the second region 32b is smaller or almost nothing compared with that of the portion corresponding to the first region 32a because the portion corresponding to the second region 32b is apart from the region 31 for the surface discharge.

Characteristics of address discharge vary according to the degradation of the protective layer 4. It is thought that a main address discharge position moves toward the outside along with the progress of the degradation in such a manner as from the region 32a to the region 32b. In particular, in a portion corresponding to the second region 32b in the range 62 for the address discharge, influence of the degradation is of course small and the secondary electron supply performance can be secured. Accordingly, the characteristics of address discharge are stabilized for a long term and the discharge delay can be suppressed, so that the address error hardly occurs. In this manner, since the stabilization of address operation can be achieved, the display quality improvement and life improvement of a panel can be realized.

As a modified example of the first embodiment, the projecting portions (Xc1, Yc1) may be made of metal electrodes like the bus electrodes (Xc, Yc) instead of the transparent electrodes. Also, the projecting shape of the projecting portions (Xc1, Yc1) and the transparent electrodes (Xa, Ya) is not limited to the rectangular shape, and various other shapes can be employed.

### Second Embodiment

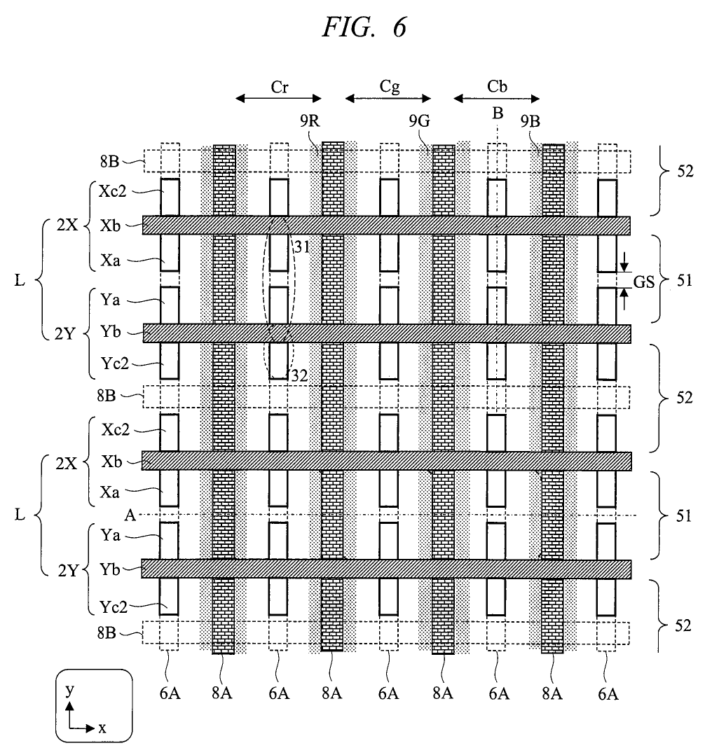

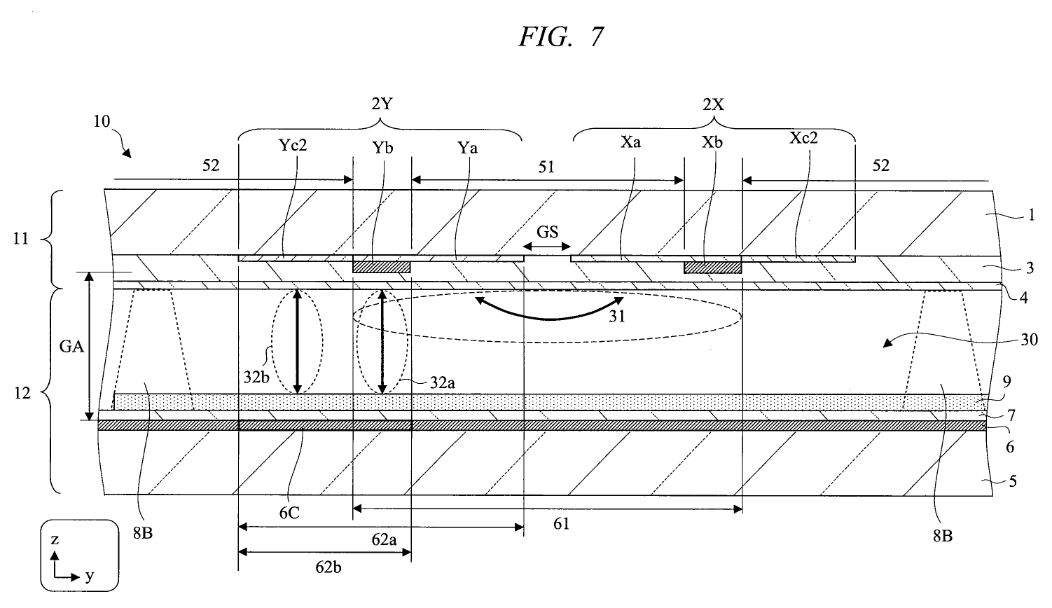

Next, a PDP 10 according to a second embodiment of the present invention will be described with reference to FIGS. 6 and 7. FIG. 6 shows a planar structure of the PDP 10 in the same manner as FIG. 12. Also, FIG. 7 shows a section B in a display column direction (y-z) shown in FIG. 6 (section A is the same as that shown in FIG. 4). The second embodiment is similar to the first embodiment regarding the basic structure including the projecting portions (Xc2, Yc2) which are the feature of the present invention and the like, and the structure of the projecting portions (Xc2, Yc2) which are the feature of the present invention is applied to the conventional configuration shown in FIG. 12. The difference in configuration from the first embodiment lies in that projection electrode portions overhung for each cell are provided on the normal slit 51 side (line L) of the display electrode pair 2 (2X, 2Y) as shown in FIG. 6. As the projection electrode portion on the normal slit 51 side, transparent electrodes (Xa, Ya) made of ITO are adopted. The surface discharge can be facilitated by the surface discharge gap GS formed by the transparent electrode pair (Xa, Ya).

In FIG. 6, the X electrode 2X and the Y electrode 2Y are composed of liner bus electrodes Xb and Yb, rectangular transparent electrodes Xa and Ya electrically connected to the bus electrodes and overhung toward the normal slit 51, and rectangular projecting portions Xc2 and Yc2 electrically connected to the bus electrodes and overhung toward the reverse slit 52. In the second embodiment, the material of the projecting portions (Xc2, Yc2) is ITO similarly to the transparent electrodes (Xa, Ya). Accordingly, the manufacturing process of a panel can be efficiently performed because the projecting portions (Xc2, Yc2) can be formed in the same step and made of the same material as the transparent electrodes (Xa, Ya).

Note that the case where the width of the bus electrodes (Xb, Yb), the width of the address electrodes 6, the width of the transparent electrodes (Xa, Ya), and the width of the projecting portions (Xc2, Yc2) are set to approximately the same size is shown here. Regarding the length in the y direction, the length of the transparent electrodes (Xa, Ya) of the normal slit 51 and the length of the projecting portions (Xc2, Yc2) of the reverse slit 52 are set to approximately the same size. Further, in the case where a lateral rib is provided, a lateral rib position 8B is an intermediate position of the reverse slit 52 and it does not overlap with the projecting portions (Xc2, Yc2).

A section B shown in FIG. 7 is a section at the position of the address electrode 6 and the projecting portions (Xc2, Yc2). The display electrodes 2 (2X, 2Y) are configured by, for example, stacking the layers of the projecting portions (Xc2, Yc2) and the transparent electrodes (Xa, Ya) made of ITO and the bus electrodes (Xb, Yb) on the glass substrate 1 in this order. The surface discharge gap GS is a distance between distal ends of the transparent electrodes (Xa, Ya) and positioned at the cell center. The address discharge gap GA is shown as a distance between the address electrode 6 and the bus electrode Yb.

In FIGS. 6 and 7, a region 31 indicated by an ellipse (surface discharge region) shows a schematic shape and range of the surface discharge. A range 61 is a range corresponding to the region 31 in the y direction. The centers of the region 31 and the range 61 are positioned near the surface discharge gap GS and a surface of the protective layer 4. Also, a region 32 indicated by an ellipse (address discharge region) shows a schematic shape and range of the address discharge. A first range 62a is a range in the y direction corresponding to a portion including all of the transparent electrode Ya, the bus electrode Yb, and the projecting portion Yc2 of the Y electrode 2Y. Also, a second range 62b is a range in the y direction corresponding to a portion including the bus electrode Yb and the projecting portion Yc2 except for the transparent electrode Ya. Further, a region 32a indicates a position of the address discharge in the case where the main address discharge occurs near a lower side of the bus electrode Yb, as a first example of a main (central) position in the address discharge. Also, a second region 32b indicates a position of the address discharge in the case where the main address discharge occurs near a lower side of the projecting portion Yc2, as a second example of a main (central) position in the address discharge. Further, a region 6C indicates a portion of the address electrode 6 corresponding to the bus electrode Yb and the projecting portion Yc2 (or a portion corresponding to a pad 6B described later).

In the PDP 10 structure, since the region 31 for surface discharge and the region 32 for address discharge in the cell are separated from each other because of the presence of the projecting portion Yc2 like the first embodiment and the degree of overlap of the regions is reduced, the influence in the address discharge performed between the Y electrode 2Y and the address electrode 6 via the protective layer 4 is reduced. Even if the degradation of the protective layer 4 due to the surface discharge moves from the cell center toward the outside, a main address discharge position moves toward the outside in such a manner as from the region 32a to the region 32b. In particular, since a portion of the protective layer 4 corresponding to the range 62b and the second region 32b for address discharge is apart from the region 31 for surface discharge, secondary electron supply performance is secured. Accordingly, characteristics of the address discharge are stabilized for a long term and discharge delay can be suppressed.

### Third Embodiment

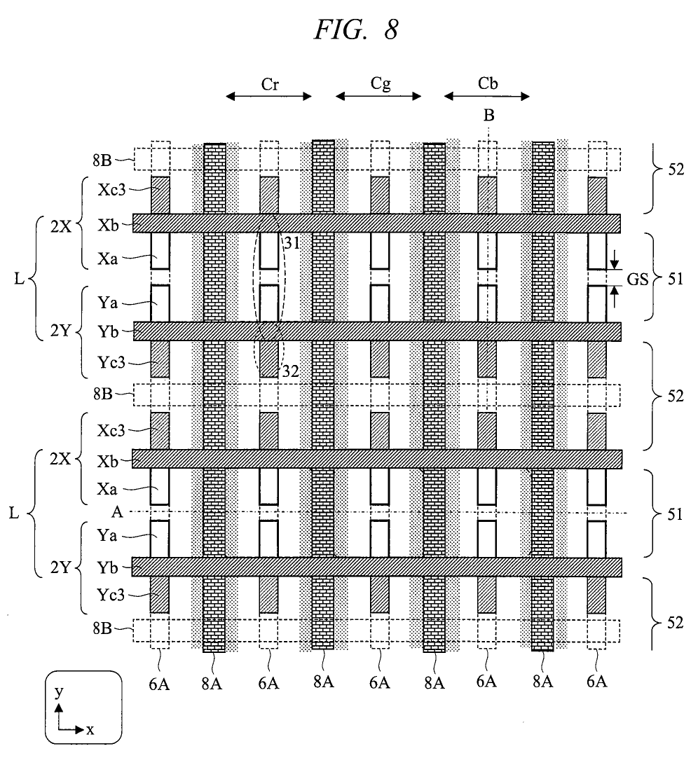

Next, a PDP 10 according to a third embodiment of the present invention will be described with reference to FIG. 8. FIG. 8 shows a planar structure of the PDP 10 in the same manner as FIG. 12. The third embodiment is similar to the second embodiment regarding the basic structure including the projecting portions (Xc3, Yc3) which are the feature of the present invention and the like, and the structure of the projecting portions (Xc3, Yc3) which are the feature of the present invention is applied to the conventional configuration shown in FIG. 12. The difference in configuration from the second embodiment lies in that projection electrode portions on the normal slit 51 side are composed of transparent electrodes (Xa, Ya) made of ITO and projecting portions (Xc3, Yc3) on the reverse slit 52 side are made of the same material as the bus electrodes (Xb, Yb) such as metal (non-transparent material).

In FIG. 8, the projecting portions (Xc3, Yc3) are made of the same material as the bus electrodes (Xb, Yb), for example, a material appearing black such as metal (for example, Cu, Cr) and are configured to have the same thickness as the bus electrodes (Xb, Yb). The projecting portions (Xc3, Yc3) are electrically connected as the portions overhung from the bus electrodes (Xb, Yb). In this structure, the projecting portions (Xc3, Yc3) form the non-transparent (for example, block) regions in the reverse slit 52 like the bus electrodes (Xb, Yb) In other words, in this structure, in a region other than the normal slit 51 (light emission region), a part of the region of the reverse slit 52 including at least the projecting portions (Xc3, Yc3) is blackened, and thus, an occupation ratio of the black region can be increased. Accordingly, an effect of improving the contrast (bright room contrast) of the screen can be achieved. Further, by forming the projecting portions (Xc3, Yc3) integrally with the bus electrodes (Xb, Yb), they can be efficiently manufactured.

Alternatively, by providing a black strip to the reverse slit 52 on the front surface side of the projecting portions (Xc, Yc) in the respective embodiments, the contrast improvement can be achieved. In this case, when the projecting portions (Xc, Yc) are concealed on the rear side of the black stripe, it is not necessary to much concern about the visual effect by the presence of the projecting portions (Xc, Yc).

### Fourth Embodiment

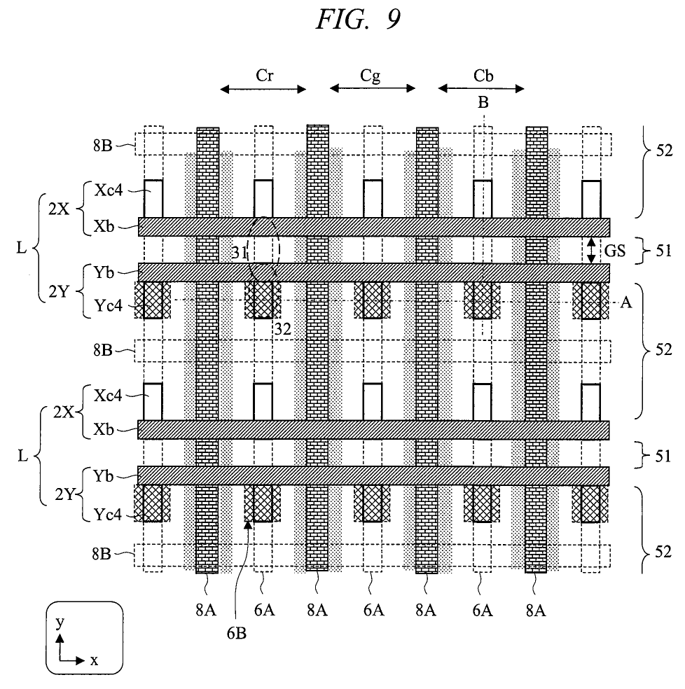

Next, a PDP 10 according to a fourth embodiment of the present invention will be described with reference to FIG. 9. FIG. 9 shows a planar structure of the PDP 10 in the same manner as FIG. 12. The fourth embodiment is similar to the second embodiment regarding the basic structure including the projecting portions (Xc4, Yc4) which are the feature of the present invention and the like. The difference in configuration from the second embodiment lies in that an address electrode 6 on the rear substrate structure 12 side is not configured to be a simple linear shape and a pad 6B which is a wider portion of the address electrode 6 is provided at a position correspondingly intersecting with a position of the projecting portion Yc4 of the Y electrode 2Y. By this means, in this structure, an area of an intersecting portion of the Y electrode 2Y including the projecting portion Yc4 and the pad 6B of the address electrode 6 is increased.

The material of the address electrode 6 including the pad 6B is metal (for example, Cu, Cr) similar to the bus electrodes (Xb, Yb). Note that it does not matter if the pad 6B portion overlaps with the bus electrode Yb portion.

The example of FIG. 9 shows the case where the width of the bus electrodes (Xb, Yb), the width of a linear main portion of the address electrode 6, the width of the transparent electrodes (Xa, Ya), and the width of the projecting portions (Xc4, Yc4) are set to approximately the same size, and in particular, the width (area) of the pad 6B of the address electrode 6 is larger than the width (area) of the projecting portion Yc4.

By adopting the structure where the area of the intersecting portion of the Y electrode 2Y and the address electrode 6 is increased, the address discharge can be generated stably and efficiently.

### Fifth Embodiment

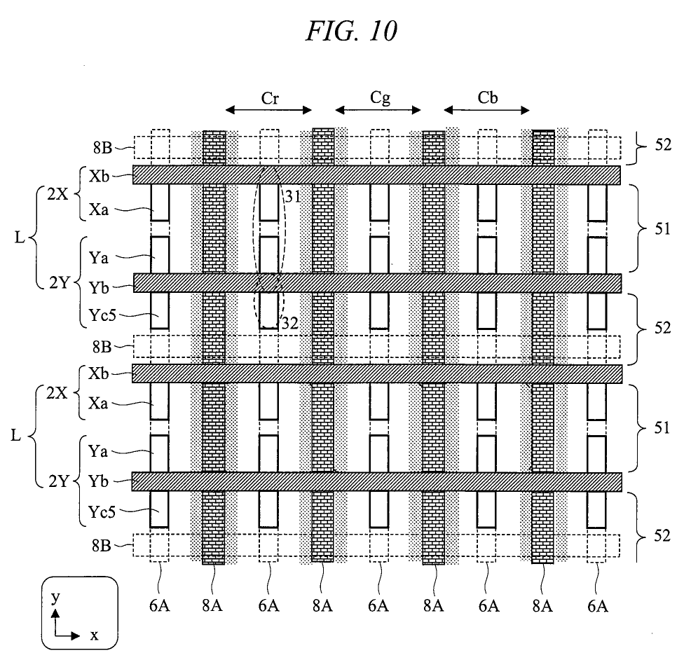

Next, FIG. 10 shows a PDP 10 according to a fifth embodiment. The fifth embodiment is basically similar to the second embodiment and the like, but the projecting portion Xc is not provided on the X electrode 2X side and the projecting portion Yc5 is provided only on the Y electrode 2Y side in the fifth embodiment. The address discharge is performed using the projecting portion Yc5 of the Y electrode 2Y or the like in the same manner as the other embodiments.

In the configuration where the projecting portions (Xc, Yc) are provided on both sides of the display electrodes 2 (2X, 2Y) as described in the above embodiments, the PDP is visually well-balanced when viewed on a screen, which leads to the improvement in display quality. On the other hand, in the configuration where the projecting portion (Yc5) is provided only on one side like this embodiment, since it is unnecessary to secure a region for the projecting portion (Xc) on the other side in the display region (cell structure), a space is increased as a whole, and this configuration is effective when a cell arrangement pitch is small.

### MODIFIED EXAMPLES

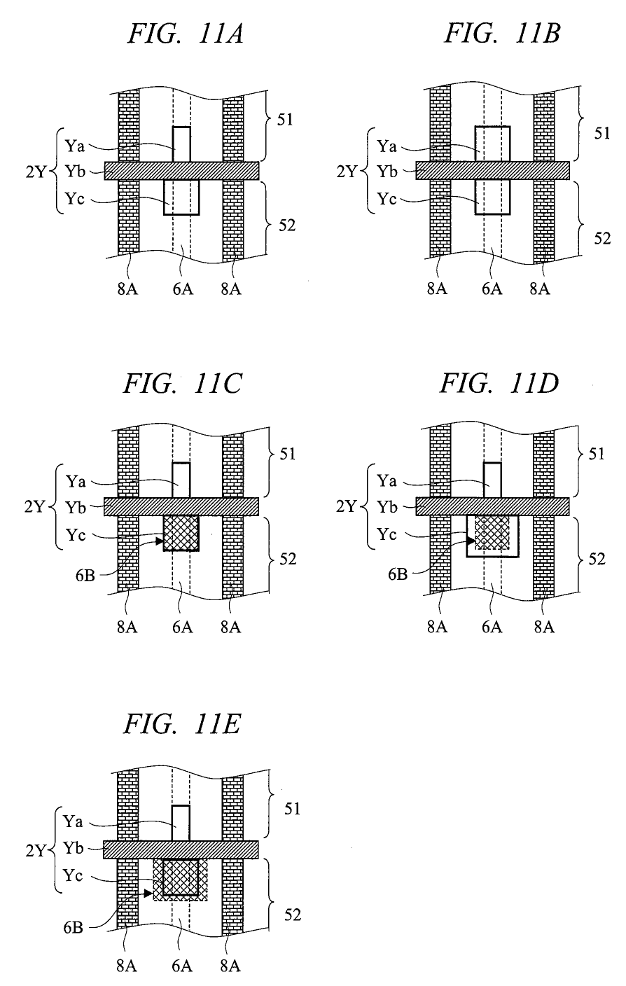

In FIGS. 11A to 11E, modified examples of respective embodiments are shown. Only a difference of a ratio of an electrode or the like in each cell is shown. In any of the modified examples, the effect of stabilizing the address discharge characteristics can be achieved similarly to the embodiments described above.

FIG. 11A shows an example where the width of the bus electrode Yb, the width of the address electrode 6, the width of the transparent electrode Ya and others are set to approximately the same size and the width of the projecting portion Yc is made larger than those.

FIG. 11B shows an example where the width of the bus electrode Yb and the width of the address electrode 6 are set to approximately the same size and the width of the transparent electrode Ya, the width of the projecting portion YC and others are equivalently made larger than those.

FIG. 11C shows an example where the width of the bus electrode Yb, the width of a main line of the address electrode 6, the width of the transparent electrode Ya and others are set to approximately the same size and the width of the projecting portion Yc and the width of the pad 6B are equivalently made larger than those.

FIG. 11D shows an example where the width of the bus electrode Yb, the width of a main line of the address electrode 6, the width of the transparent electrode Ya and others are set to approximately the same size, the width of the pad 6B is made larger than those, and further, the width (area) of the projecting portion Yc is made larger than the width (area) of the pad 6B.

FIG. 11E shows an example where the width of the bus electrode Yb, the width of a main line of the address electrode 6, the width of the transparent electrode Ya and others are set to approximately the same size, the width (area) of the projecting portion Yc is made larger than those, and further, the width (area) of the pad 6B is made larger than the width (area) of the projecting portion Yc.

Also, regarding the above-mentioned embodiments, specific examples of thickness and width of the electrodes and others are described below. The thickness of the metal bus electrodes 5 (Xb, Yb) is larger than the thickness of the transparent electrodes (Xa, Ya) made of ITO. For example, the thickness of the bus electrodes (Xb, Yb) is in a range of 2 to 5 μm, and the thickness of the transparent electrodes (Xa, Ya) is in a range of 1,000 to 2,000 Å (Angstrom). For example, the width of the bus electrodes (Xb, Yb) is in a range of 50 to 60 μm, the width of the address electrode 6 is in a range of 40 to 50 μm, the width of the pad 6B of the address electrode 6 is 100 μm, and the width of the various projecting portions (Xc, Yc) is 80 μm.

In the foregoing, the invention made by the inventors of the present invention has been concretely described based on the embodiments. However, it is needless to say that the present invention is not limited to the foregoing embodiments and various modifications and alterations can be made within the scope of the present invention.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications within the ambit of the appended claims.

What is claimed is:

1. A plasma display panel comprising: a substrate structure having a discharge space which is partitioned by barrier ribs and in which phosphors are formed, the substrate structure including pairs of first and second electrodes used for surface discharge and extending in a first direction and third electrodes used for address discharge performed between the third electrode and the second electrode and extending in a second direction intersecting with the first direction, and display cells being formed correspondingly to intersections of these electrodes,
wherein a dielectric layer covering the first and second electrodes and a protective layer covering the dielectric layer and exposed to the discharge space are provided,
a slit on one side in the pair of the first and second electrodes is used for the surface discharge and a slit on an opposite side is not used for the surface discharge, and
first projection-shaped electrode portions used for the address discharge are provided to the second electrode so as to extend toward the slit on the opposite side and be included in a region of the discharge space corresponding to the display cell.

2. The plasma display panel according to claim 1,
wherein the first projection-shaped electrode portions are provided to the first electrode so as to extend toward the slit on the opposite side similarly to those of the second electrode.

3. The plasma display panel according to claim 1,
wherein second projection-shaped electrode portions used for the surface discharge are provided to the first and second electrodes so as to extend toward the slit on the one side.

4. The plasma display panel according to claim 3,
wherein main lines of the first and second electrodes are formed of metal bus electrodes, and
the first and second projection-shaped electrode portions are formed of transparent electrodes, respectively.

5. The plasma display panel according to claim 3,
wherein main lines of the first and second electrodes are formed of metal bus electrodes, and
the first projection-shaped electrode portions are formed of metal electrodes and the second projection-shaped electrode portions are formed of transparent electrodes.

6. The plasma display panel according to claim 1,
wherein a pad portion with a large width in the third electrode is provided at a position intersecting with the first projection-shaped electrode portion.

7. The plasma display panel according to claim 1,
wherein a first barrier rib portion that partitions the discharge space correspondingly to the display cells in parallel to the second direction is provided between the third electrodes in the substrate structure.

8. The plasma display panel according to claim 7,
wherein a second barrier rib portion that partitions the discharge space correspondingly to the display cells in parallel to the first direction is provided to the slit on the opposite side in the substrate structure.
